(19) United States
(12) Patent Application Publication
(10) Pub. No.: US 2015/0266123 A1
(43) Pub. Date: Sep. 24, 2015

(54) HEATING UNIT AND VACUUM WELDING MACHINE INCLUDING THE SAME

(71) Applicant: Yongfa Joyful Industry Co., Ltd, New Taipei City (TW)

(72) Inventors: Wen-Hsuan LAI, New Taipei City (TW); Wen-Feng LAI, New Taipei City (TW); Wen-Tien LAI, New Taipei City (TW)

(21) Appl. No.: 14/662,024

(22) Filed: Mar. 18, 2015

(30) Foreign Application Priority Data
Mar. 18, 2014 (TW) 103110154

(51) Int. Cl. B23K 1/005; H05B 3/00; B23K 3/047

(52) U.S. Cl. CPC B23K 1/0053; B23K 3/047; H05B 3/0038

(57) ABSTRACT

A heating unit and a vacuum welding machine including the same are provided. The heating unit includes a cover body and a heating light source. An inward concave part is formed on a surface of the cover body. A reflecting surface is formed on a surface of the inward concave part. A water pipe is provided to penetrate the cover body to enable cooling water flowing therethrough to dissipate heat generated by the heating unit. The heating light includes a heating lamp tube disposed in the inward concave part, and is concentrated by the reflecting surface. Two top ends of the inward concave part are respectively disposed with a connecting part, such that two heating units are connected by the connecting part and then a plurality of heating units is merged as a heater of the vacuum welding machine to promote the heating and dissipating effects.

### CROSS-REFERENCE TO RELATED APPLICATION

This application claims priority from Taiwan Patent Application No. 103110154, filed on Mar. 18, 2014, in the Taiwan Intellectual Property Office, the content of which are hereby incorporated by reference in their entirety for all purposes.

### BACKGROUND OF THE INVENTION

1. Field of the Invention

This application relates to a heating unit and a vacuum welding machine including the same which are applied to the field of vacuum welding, and more particularly, to a heating unit which is able to be merged as a heater for being served as a heating device of the vacuum welding machine.

2. Description of the Related Art

In the welding process, the solder having lower melting point is added between two work pieces in terms of methods of brazing and soldering. After being heated, the solder is filled in the joint of the two work pieces due to its flowability, and then the two work pieces are able to be jointed when the solder solidifies. The difference between the methods of brazing and soldering lies in the diversity of the melting point of the solder, and moreover, the working environment and the heating method have great impact upon the welding process. The contaminants between the solder melted at high temperature and the work piece may affect the strength of the welding. As a result, controlling the heating and cooling in the welding process directly plays a critical role in maintaining the quality of welding.

Currently, the vacuum welding method may be applied to maintain the consistency of welding and to produce the product having higher strength and lower variability. That is to say, the radiation heating method may be applied to melt the solder so as to perform the welding in a vacuum environment. As the vacuum environment is able to reduce the production of the contaminants between the work pieces, the products produced in such manufacturing process are therefore of higher quality and reliability. However, the conditions of evacuating the reaction chamber and heating device of the welding machine are not able to be modified according to the work piece, and moreover, the radiation heating method applied to melt the solder and the follow-up cooling method all have the technical problems in terms of the vacuum welding method.

Accordingly, the present invention provides a modularized heating unit which is able to be merged to form a heater to cooperate with the work piece, such that the heating and cooling methods are able to be performed more effectively. Additionally, the work piece being welded by the vacuum machine in the vacuum environment may improve the preceding drawbacks.

### SUMMARY OF THE INVENTION

In view of the aforementioned technical problems, the objective of the present invention is to provide a heating unit and a vacuum welding machine including the same to resolve the technical problems of the conventional vacuum welding machines. For example, the heating apparatus of the conventional vacuum welding machine may be a stationary structure, and the heating light source is not able to be adjusted according to the actual requirements, such that the solder may be heated unequally due to the temperature. Hence, by means of the arrangement of the heating unit, the heating and dissipating efficiencies of the vacuum machine may be promoted greatly.

According to one objective of the present invention, a heating unit is provided, which may include a cover body and a heating light source. An inward concave part which is groove-shaped may be formed on a surface of the cover body, a reflecting surface may be formed on a surface of the inward concave part, and a water pipe may be provided, to penetrate the cover body to enable cooling water flowing through the water pipe for dissipating heat generated by the heating unit. The heating light source may include a heating lamp tube disposed in the inward concave part, and may be concentrated by the reflecting surface. The inward concave part includes two top ends at both sides of the inward concave part and the two ends include a set of connecting parts, such that two heating units are connected by the set of connecting parts and then a plurality of heating units may be merged thereby.

Preferably, the set of connecting parts may include a protrusion and a connecting ring respectively disposed at the two top ends of the inward concave part, so that the adjacent heating units are connected to each other and an angle of the adjacent heating units may be adjusted by rotating the connecting ring.

Preferably, a material of the cover body may include aluminum.

Preferably, the heating unit may further include a metal thin film coated on the reflecting surface, and a material of the metal thin film may include gold, silver or platinum.

According to another objective of the present invention, a vacuum welding machine is provided, which may include a reaction chamber, a heater and a controller. The reaction chamber may be disposed on a machine body and connected to an evacuation device. The reaction chamber may include a carrier carrying and transferring a work piece. The heater which includes the aforementioned heating units may be connected and disposed circularly along the reaction chamber. The controller may be connected respectively to the reaction chamber, the evacuation device and the plurality of heating units, and may actuate the reaction chamber to carry the work piece, evacuate the reaction chamber and control a temperature of the heating lamp tube.

Preferably, the reaction chamber may include a quartz cavity or a stainless steel cavity.

Preferably, the reaction chamber may be a vertical type reaction chamber or a horizontal type reaction chamber.

Preferably, the plurality of the heating units may be connected and disposed along the reaction chamber with a circular shape, a semicircular-ring shape or a planar shape.

Preferably, a heat dissipation pipe may be further disposed around the evacuation device to enable cooling water flowing through the heat dissipation pipe, so as to dissipate heat generated by the evacuation device.

Preferably, a heat dissipating fin may contact with the reaction chamber, and a tube may be disposed inside the heat dissipating fin to enable cooling water flowing through the tube, so as to dissipate heat generated by the reaction chamber.

In conclusion, the heating unit and the vacuum welding machine including the same of the present invention may have one or more advantages as follows.

1. The heating unit and the vacuum welding machine including the same of the present invention may enable the user to merge the heating units to form various heating modules according to different features of the work piece, such that the usage convenience can be promoted.

2. The heating unit and the vacuum welding machine including the same of the present invention applies the reflecting surface of the heating unit to concentrate light, so as to effectively promote the efficiency of the heating light and the welding process.

3. The heating unit and the vacuum welding machine including the same of the present invention applies the water pipe penetrating the heating unit and the dissipating tube of the vacuum welding machine to enable the cooling water to take the unnecessary heat energy away, so as to achieve the optimal dissipating heat effect.

### BRIEF DESCRIPTION OF THE DRAWINGS

FIG. 1 is a schematic diagram of a cover body of a heating unit of the present invention.

FIG. 2 and FIG. 3 are the schematic diagrams of a merged cover body of a heating unit of the present invention.

FIG. 4 is a block diagram of a vacuum welding machine of the present invention.

FIG. 5 is a schematic diagram of a heating unit of a vacuum welding machine of the present invention.

FIG. 6 is a schematic diagram of another heating unit of a vacuum welding machine of the present invention.

FIG. 7 is a schematic diagram of a vacuum welding machine of the present invention.

FIG. 8 is a schematic diagram of another heating unit of a vacuum welding machine of the present invention.

FIG. 9 is a schematic diagram of a water pipe of a heater of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

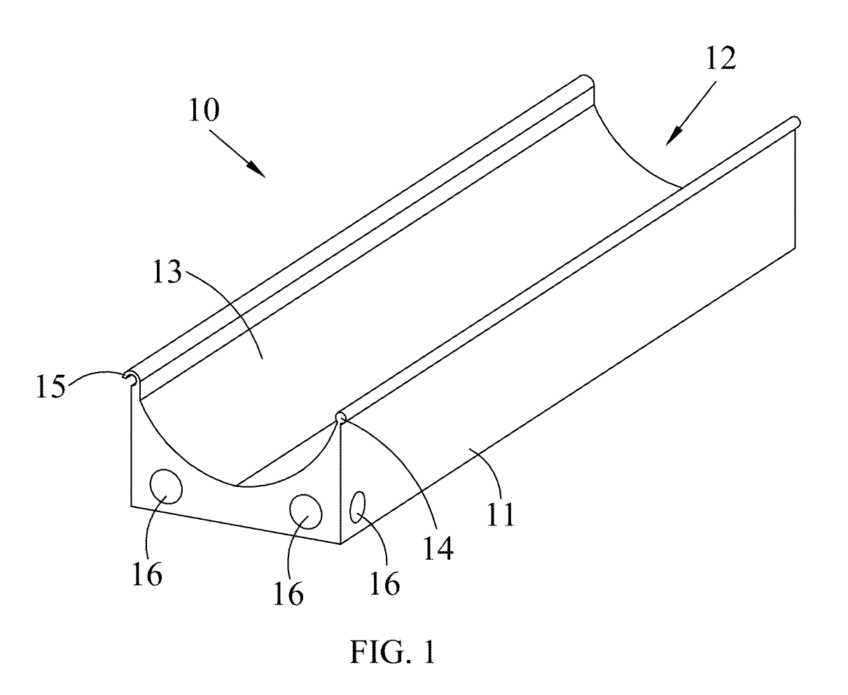

Please refer to FIG. 1 which is a schematic diagram of a cover body of a heating unit of the present invention. As shown in the Fig., a cover body 10 is a rectangular-shaped aluminum strip 11. An inward concave part 12 which is groove-shaped is disposed on a surface of the cover body 10, and the inward concave part 12 curves inwardly along the entire aluminum strip 11 to form a semicircular-ring shape for being served as a reflecting surface 13 used to concentrate light. Two top ends of two sides of the inward concave part 12 are respectively disposed with a protrusion 14 and a connecting ring 15, wherein the protrusion 14 and the connecting ring 15 are served as a set of connecting parts of the cover body 10, such that the two adjacent cover bodies 10 are able to be clamped and the connecting ring 15 is able to be rotated to adjust the merged angle of the two adjacent cover bodies. The structure of the aluminum strip 11 and the set of connecting parts are made of a method of aluminum extrusion, and the length of the aluminum strip 11 can be adjusted according to the work piece or the welding machine. So, the manufacture of the present invention is more flexible. In addition, a metal thin film is able to be coated on the reflecting surface 13, and a material of the metal thin film may include gold, silver or platinum. As the applied material is of better heat resistance and reflectivity, the light-concentrating effect can be promoted further. A water pipe 16 is provided to penetrate inside the aluminum strip 11 to enable cooling water flowing through the water pipe 16 so as to be an effective way of heat dissipation.

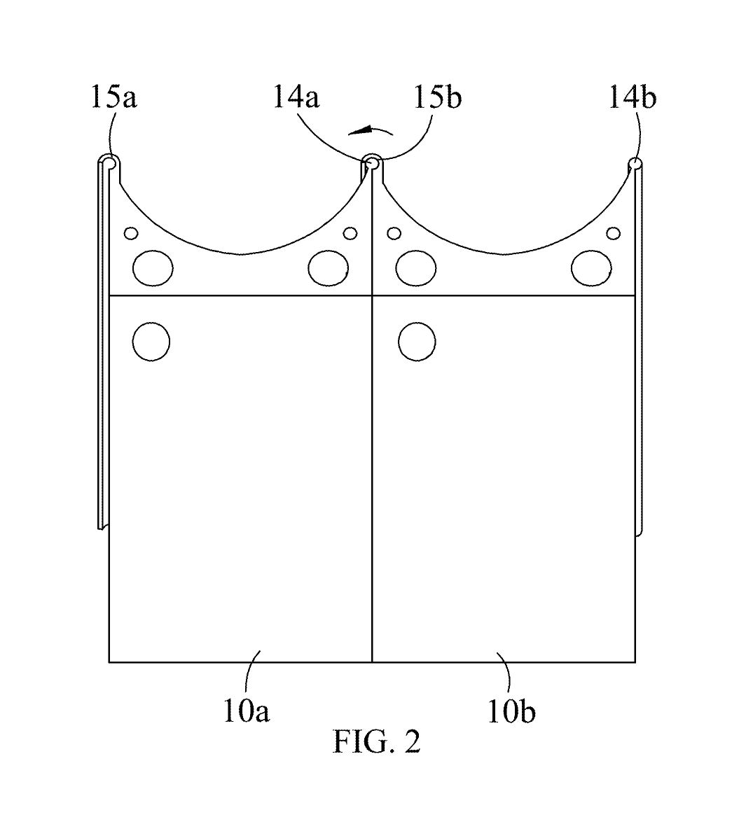

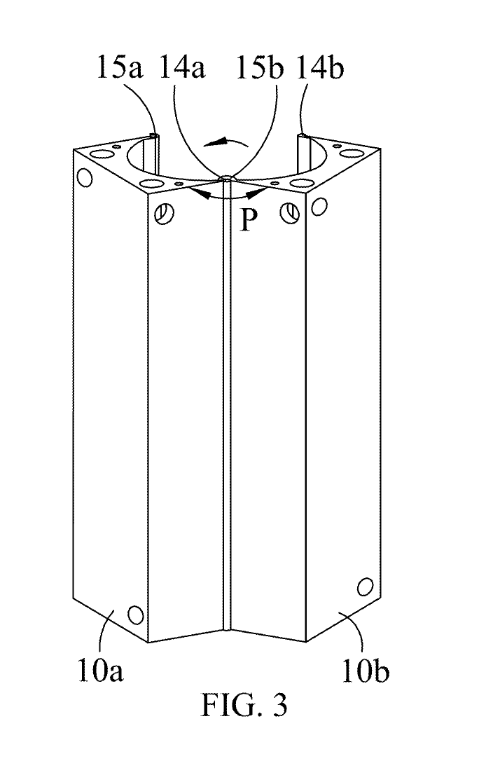

Please refer to FIG. 2 and FIG. 3 which are the schematic diagrams of a merged cover body of a heating unit of the present invention. As shown in the Figs., the protrusions 14a, 14b and the connecting rings 15a, 15b are respectively disposed at the top ends of the two sides of the inward concave part of the two aluminum cover bodies 10a, 10b. FIG. 2 shows that the protrusion 14a of the cover body 10a is connected to the connecting ring 15b of the cover body 10b, so that the cover body 10a is merged to the cover body 10b. The embodiment shall be not limited in two cover bodies. The other cover bodies are able to be connected according to the method based on the actual requirements. As shown in FIG. 2, the connected cover bodies may be a horizontal combination by sealing the sides thereof, or the two cover bodies 10a, 10b may be adjusted as an angle P by rotating the connecting ring 15b and the protrusion 14a. Adjusting the angle between the two cover bodies is mainly to adjust the angle of the reflecting surface formed in the inward concave part of the cover bodies 10a, 10b, so as to further achieve a better light-concentrating effect. Consequently, the angle P may be decided according to the wielding process or the welding machine.

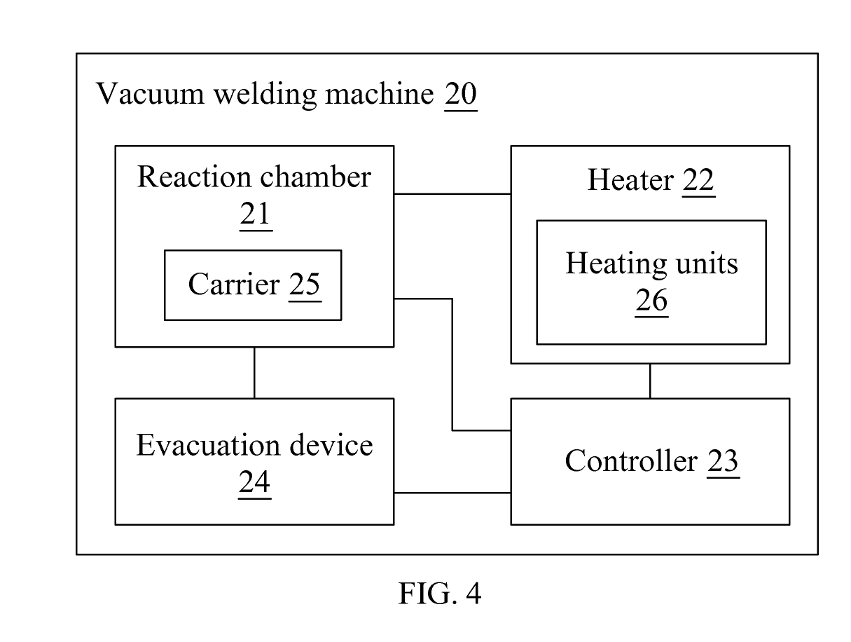

Please refer to FIG. 4 which is a block diagram of a vacuum welding machine of the present invention. As shown in the Fig., a vacuum machine 20 includes a reaction chamber 21, a heater 22 and a controller 21. The reaction chamber 21 is a cavity made by a quartz tube and the reaction chamber 21 is connected to an evacuation device 24. The evacuation device 24 may be a vacuum pump. The reaction chamber 21 is performed as a vacuum chamber by using the evacuation device 24. A carrier 25 which is applied to carry a work piece is disposed inside the reaction chamber 21. The carrier 25 includes a transfer device and a sealing device, wherein the transfer device is applied to transfer the work piece, and the sealing device is applied to seal the reaction chamber 21 when the work piece is transferred in the reaction chamber 21. The transfer device and the sealing device may be an oil pressure structure or an electrically-driven structure. The heater 22 includes a plurality of heating units 26, and is disposed outside the reaction chamber 21. The heater 22 applies a heating lamp tube to irradiate the reaction chamber 21 to perform the welding process. The combination and the merged method of the heating units 26 will be described in the following embodiment. The vacuum machine 20 further includes the controller 23 which is respectively connected to the reaction chamber 21, the evacuation device 24 and the heater 22. The controller 23 may be a relay sequential controller (such as a switch, a timer), or a programmable controller. The controller 23 operates the work piece transferring to the reaction chamber 21, and then the reaction chamber 21 is sealed and evacuated. Besides, the controller 23 further controls the heating lamp tube of the heater 22 to perform the welding process and then cool the reaction chamber 21 when reaching to the temperature of welding. The controller 23 may be designed as various means of operating buttons or a touch panel according to the actual requirement.

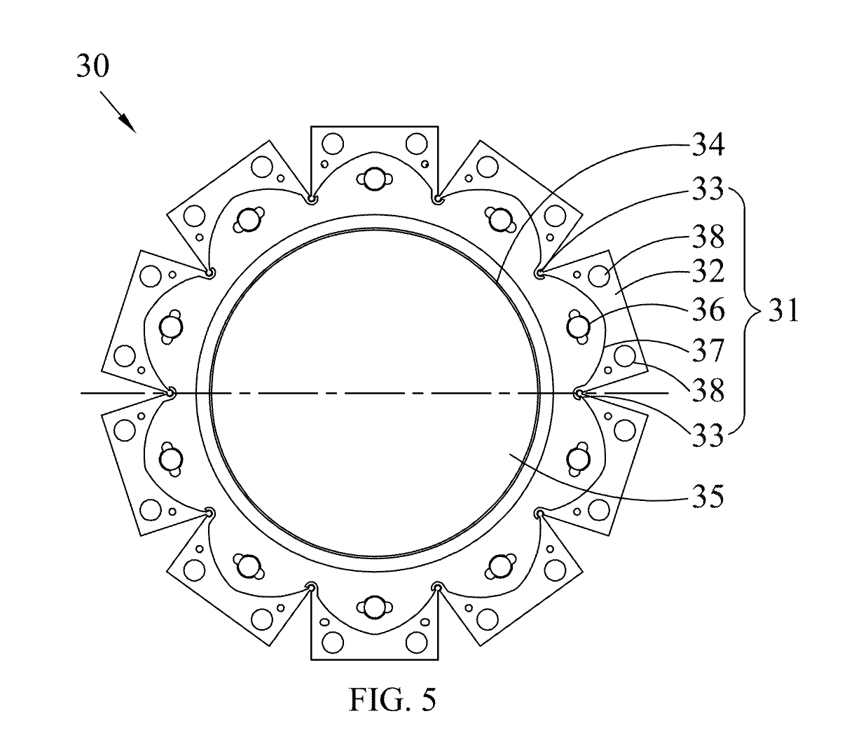

Please refer to FIG. 5 which is a schematic diagram of a heating unit of a vacuum welding machine of the present invention. As shown in the Fig., the heater 30 includes ten heating units 31, and the ten heating units 31 are merged a circle by connecting the protrusions and the connecting rings disposed on each cover body 32, and the merged heating unit is arranged circularly outside the reaction chamber 35. Each heating unit 31 includes the cover body 32 and a heating light, and each heating light includes a heating lamp tube 36, but it shall be not limited thereto. The heating light of each heating unit 31 may include a plurality of heating lamp tubes 36, or different heating units 31 may include the heating lamp tube 36 having various heating lights. Wherein, a single heating lamp tube 36 may include one or more lighting thermal elements disposed therein, and the lighting thermal element may be a lamp filament. Other than irradiating on the reaction chamber 35 directly, the radiation heat of the heating lamp tube 36 may be reflected into the reaction chamber 35 by the reflecting surface 37 of the cover body 32, so as to promote the heating efficiency. As to the huge amount of the heat energy of the heating light source, the water pipe 38 is provided to penetrate the heating unit 31 to be arranged therein. The cooling water is applied to take the heat energy away to dissipate the heat effectively. When heating the solder to the melting point and cooling it to solidification in welding process, the operation time plays a critical role in the welding quality. As a result, the present invention is able to promote the effect of the aforementioned two aspects so as to achieve a better welding quality.

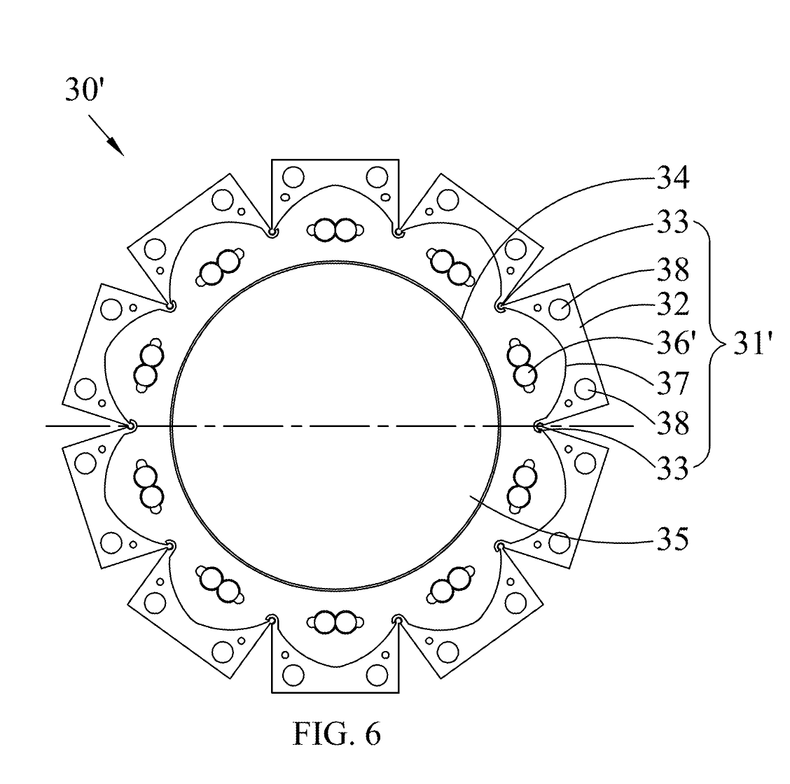

FIG. 6 is a schematic diagram of another heating unit of a vacuum welding machine of the present invention. A heater 30′ shown in FIG. 6 and the heater 30 shown in FIG. 5 both include ten heating units and are merged as a circular shape. Hence, details of the identical structure are no longer given herein. What the difference between the present embodiment and the aforementioned embodiment lies in that the heater 30′ includes a heating lamp tube 36′, and more than two lamp filaments are included inside the heating lamp tube 36′. Wherein, the lamp filaments may have the same spectrum, or may be able to be combined with the lamp filaments having different spectrums. The applied type depends on the necessary light when welding the work piece.

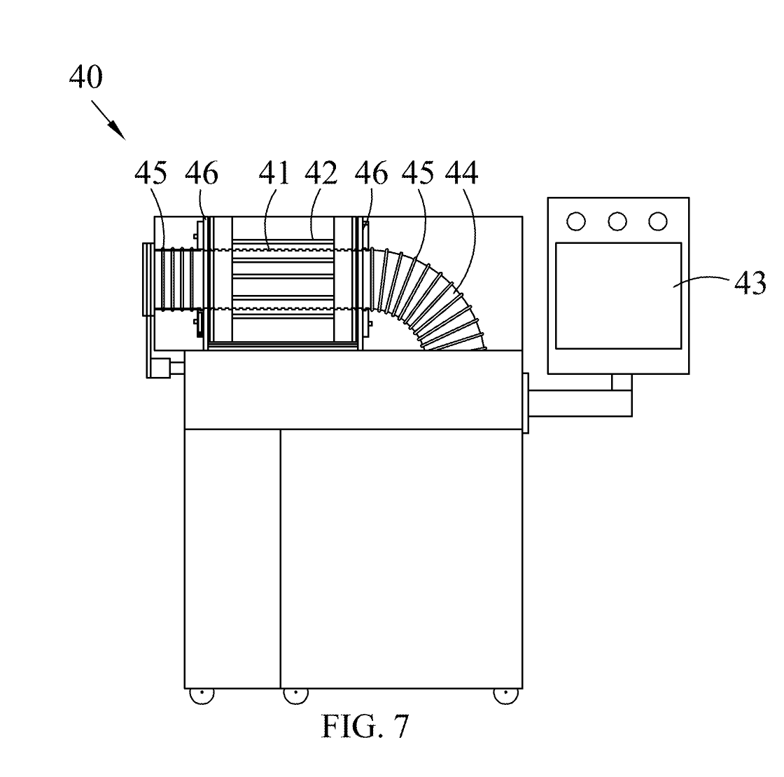

FIG. 7 is a schematic diagram of a vacuum welding machine of the present invention. As shown in the Fig., the vacuum welding machine 40 includes the reaction chamber 41, the heating lamp tube 42 and a control panel 43. The reaction chamber 41 is connected to the vacuum device 44, and is sealed and evacuated to form a vacuum state when the carrier completes the transfer. Afterwards, the surrounding heating lamp tube 42 heats the reaction chamber 41 to a melting temperature which is necessary for the welding. As the high temperature generated in the welding process is not only transmitted to the reaction chamber 41, but also to the other apparatus of the vacuum welding machine 40, in order to avoid the apparatus being damaged due to the high temperature, the dissipating heat tube 45 may be disposed outside the tube of the evacuation device 44 or outside the carrying device, such that the cooling water may flow through the devices to take the redundant heat energy so as to prevent the devices from being damaged. Two heat dissipating fins 46 are disposed adjacent to the reaction chamber 41 and directly contact two ends of the reaction chamber 41, wherein, the heat dissipating fin 46 is formed of the metal having better heat dissipating effect. The tube is further disposed inside the heat dissipating fin 46, and dissipates the heat by the cooling water. The reaction chamber of the vacuum welding machine 40 of the present embodiment applied to weld is a horizontal type reaction chamber, but it shall be not limited thereto. The arrangement of reaction chamber of the vacuum machine 40 of the present embodiment may be a vertical type reaction chamber to cooperate with the various transfer methods to weld the work piece.

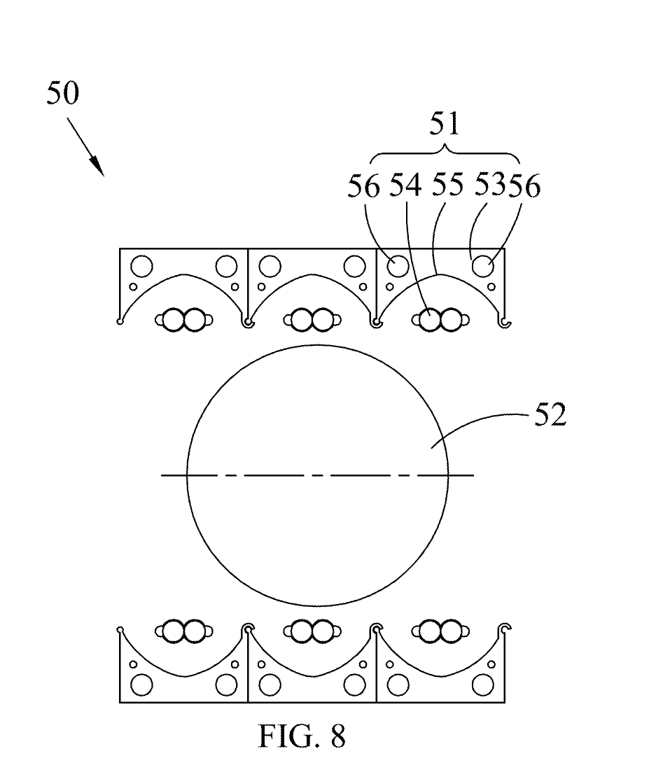

FIG. 8 is a schematic diagram of another heating unit of a vacuum welding machine of the present invention. As shown in the Fig., the heater 50 is a combination formed by emerging three heating units 51, and is arranged above and below the reaction chamber 52. Each heating unit 51 includes the cover body 53 and the heating lamp tube 54, and the heating lamp tube 54 may be formed of one or more lamp tubes, or each lamp tube may include more than one lamp filament. Other than irradiating on the reaction chamber 52 directly, the radiation heat of the heating lamp tube 54 may be reflected into the reaction chamber 52 through the reflecting surface 55 of the cover body 53, so as to promote the heating efficiency. The heating unit 51 is also disposed with the water pipe 56 which penetrates the heating unit 51, and the cooling water is able to flow through the heating unit 51 to take the heat away so as to dissipate the heat. The arrangement of the water pipe 56 will be described in the flowing paragraph. As the plural heating units Si are merged horizontally, the directions where the reflecting surface 55 and the heating lamp tube 54 form the heating light are different from the arrangement of the circular shape, or the semicircular-ring shape. The adjustment mainly aims to the various characteristics of the work piece and the solder, such that the optimal effect of the weld may be achieved thereby.

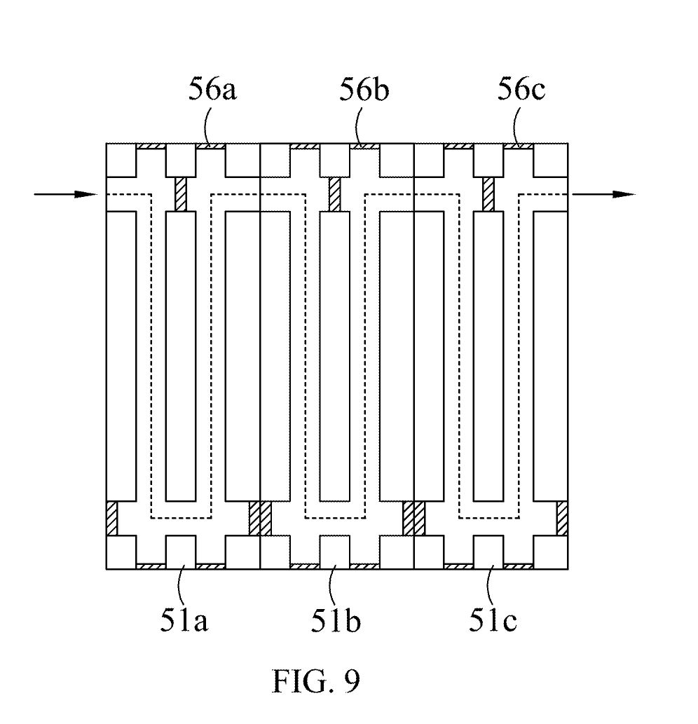

FIG. 9 is a schematic diagram of a water pipe of a heater of the present invention. As shown in the Fig., three heating units 51a, 51b, and 51c are disposed with three water pipes 56a, 56b and 56c, respectively, and the water inlets and the water outlets are disposed vertically and horizontally to the water pipes. In order to dissipate the heat through a water loop method, partial openings of the pipes are able to be blocked to set a fixed water loop, such that the cooling water can dissipate the heat generated by the three heating units 51a, 51b, and 51c equally. The mentioned above belongs to one of the arrangements of the water pipe, and it shall be not limited thereto. Various connections or water loops which are able to be applied to dissipate heat are all encompassed in the scope of the present invention.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A heating unit, comprising:
a cover body, having an inward concave part being groove-shaped on a surface of the cover body, a reflecting surface formed on a surface of the inward concave part, a water pipe provided to penetrate inside the cover body to enable cooling water flowing through the water pipe, for dissipating heat generated by the heating unit; and
a heating light source comprising a heating lamp tube disposed in the inward concave part, and the heating light source concentrated by the reflecting surface;
wherein the inward part comprises two top ends at both sides of the inward concave part and the two top ends comprise a set of connecting parts, such that two heating units are connected by the set of connecting parts and a plurality of heating units are merged accordingly.

2. The heating unit of claim 1, wherein the set of connecting parts comprises a protrusion and a connecting ring respectively disposed at the two top ends of the inward concave part, so that the adjacent heating units are connected to each other and an angle of the adjacent heating units is adjusted by rotating the connecting ring.

3. The heating unit of claim 1, wherein a material of the cover body comprises aluminum.

4. The heating unit of claim 1, further comprising a metal thin film coated on the reflecting surface, and a material of the metal thin film comprising gold, silver or platinum.

5. A vacuum welding machine, comprising:
a reaction chamber disposed on a machine body and connected to an evacuation device, and the reaction chamber comprising a carrier carrying and transferring a work piece;
a heater comprising the plurality of heating units of claim 1, and the plurality of heating units connected and disposed circularly along the reaction chamber;
a controller respectively connected to the reaction chamber, the evacuation device and the plurality of heating units, and actuating the reaction chamber to carry the work piece, evacuate the reaction chamber and control a temperature of the heating lamp tube.

6. The vacuum welding machine of claim 5, wherein the reaction chamber comprises a quartz cavity or a stainless steel cavity.

7. The vacuum welding machine of claim 5, wherein the reaction chamber is a vertical type reaction chamber or a horizontal type reaction chamber.

8. The vacuum welding machine of claim 5, wherein the plurality of the heating units are connected and disposed along the reaction chamber with a circular shape, a semicircular-ring shape or a planar shape.

9. The vacuum welding machine of claim 5, further comprising a heat dissipation pipe disposed around the evacuation device to enable cooling water flowing through the heat dissipation pipe, so as to dissipate heat generated by the evacuation device.

10. The vacuum welding Machine of claim 5, further comprising a heat dissipating fin contacted with the reaction chamber, and a tube disposed inside the heat dissipating fin to enable cooling water flowing through the tube, so as to dissipate heat generated by the reaction chamber.
